(19) United States
(12) Patent Application Publication
(10) Pub. No.: US 2004/0035011 A1
(43) Pub. Date: Feb. 26, 2004

(54) Measurement instrument with light emitting source

(75) Inventors: Christopher Robert Carlson, Wausau, WI (US); Robert William Cornell, Schofield, WI (US); Jason Wolf, Schofield, WI (US); Kevin Leigh Imhoff, Wausau, WI (US)

Correspondence Address: FOLEY & LARDNER, 321 NORTH CLARK STREET, SUITE 2800, CHICAGO, IL, 60610-4764, US

(73) Assignee: Alterra Holdings Corporation

(21) Appl. No.: 10/228,348

(22) Filed: Aug. 26, 2002

(51) Int. Cl. B43L 7/10

(52) U.S. Cl. 33/424

(57) ABSTRACT

A measuring instrument comprising a frame and a plurality of measurement indicia. A power source is positioned inside a portion of the frame with a light source operatively connected to the power source. When a user presses down upon the frame, the light source is actuated, sending light throughout the frame and illuminating the measurement indicia, providing improved visibility for a user.

### FIELD OF THE INVENTION

The present invention is directed generally to measurement instruments. More particularly, the present invention is related to measurement instruments that include a mechanism that permits a user to easily view the measurement indicia contained thereon.

### BACKGROUND OF THE INVENTION

Measurement instruments, such as protractors and rulers, are conventionally known and are used in a variety of fields and industries. In particular, protractors and rulers are frequently used by school children who are learning how to define and describe angular and linear measurements, in addition to drawing lines and shapes that incorporate the measurements.

A conventional protractor or ruler includes a plurality of measurement indicia located on at least one side of the instrument. For example, a ruler often includes indicia to represent linear measurements in inches, centimeters, millimeters and/or other measurement quantities. Similarly, protractors may include both linear and angular measurements, with the angular measurements indicating the number of degrees from a zero degree line of reference.

Because young school children often must use rulers, protractors and other instruments, to not only learn the basics of geometry, but also to understand how to measure the length and angles of certain objects, it is important that they are able to easily identify the particular indicia of measurement on these measurement instruments. In many prior art measurement devices, however, the measurement indicia can be difficult to identify with the naked eye, either because of the contrast between the indicia and the background surface or because certain indicia, such as millimeter markings, are too close together to be easily distinguished. Additionally, measurement instruments directed to school children often include an additional need to keep the student's interest. If a school-related product includes additional features which pique the student's interest, then the student will be more likely to continue learning how to use the instruments.

### SUMMARY OF THE INVENTION

It is therefore an object of the invention to provide an improved measurement instrument that more clearly delineates a plurality of measurement indicia on at least one surface of the instrument.

It is another object of the invention to provide an improved measuring instrument that provides a plurality of measurement indicia that can be easily seen by a user.

It is a further object of the invention to provide an improved measuring instrument that allows a user to view the measuring indicia with a high degree of accuracy in a relatively dark environment.

It is still another object of the invention to provide an improved measuring instrument that provides for an increased level of interest in a young user.

In accordance with these objects of the invention, a measuring instrument is provided comprising a frame and a plurality of measurement indicia. A power source is positioned inside a portion of the frame with a light source operatively connected to the power source. When a user presses down upon the frame, the light source is actuated, sending light throughout the frame and illuminating the measurement indicia, providing improved visibility for a user.

These and other objects, advantages and features of the invention, together with the organization and manner of operation thereof, will become apparent from the following detailed description when taken in conjunction with the accompanying drawings, wherein like elements have like numerals throughout the drawings described below.

### BRIEF DESCRIPTION OF THE DRAWINGS

FIG. 1 is a perspective view of one type of measurement instrument according to one embodiment of the invention;

FIG. 2 is a reverse perspective and exploded view of the measurement instrument of FIG. 1;

FIG. 3 is a perspective view of a measurement instrument according to a different embodiment of the invention;

FIG. 4 is a perspective and exploded view of the measurement instrument of FIG. 3;

FIG. 5 is a front view of a measurement instrument according to another embodiment of the invention;

FIG. 6 is a magnified view of a plurality of indicia according to one embodiment of the invention;

FIG. 7 is a magnified perspective view of a single groove of one of the plurality of indicia;

FIG. 8 is a front view of a single groove according to one embodiment of the invention;

FIG. 9 is a front view of a single groove according to another embodiment of the invention;

FIG. 10 is a front view of a single groove according to yet another embodiment of the invention; and

FIG. 11 is a front view of a single groove according to still another embodiment of the invention.

### DETAILED DESCRIPTION OF THE INVENTION

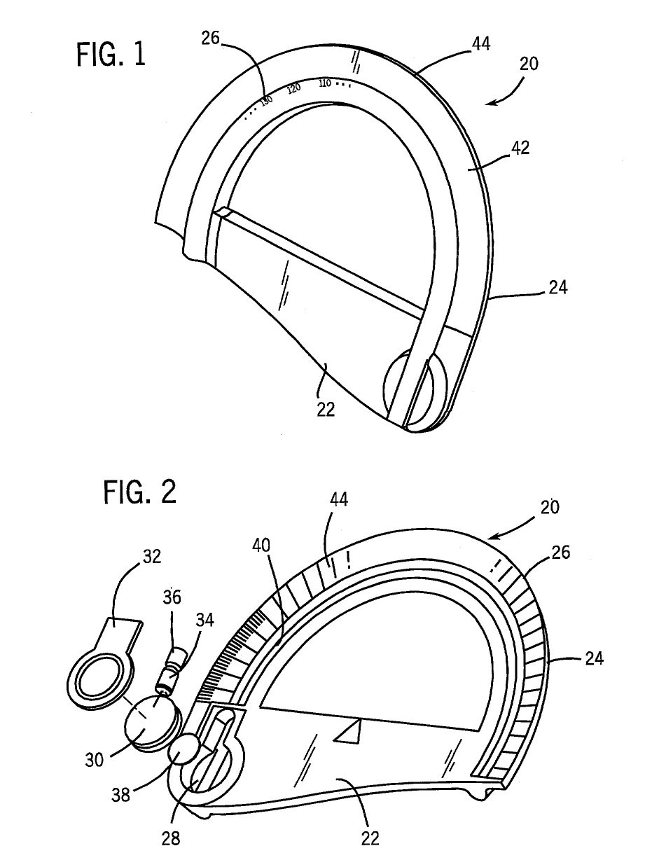

A measurement instrument in the form of a protractor is shown generally at 20 in FIGS. 1 and 2. The protractor 20 includes a base 22 integrally connected to an arc portion 24 at each end thereof. The protractor 20 also includes a front side 42 and a back side 44. The arc portion 24 includes a plurality of indicia 26 include thereon or therein. In this particular embodiment of the invention, the indicia 26 mark the number of degrees of an angle that is defined from the edge of the base 22 to that particular portion of the indicia 26. The plurality of indicia 26 can also mark measurements of linear distance (such as in inches, centimeters, etc.) and can also include lettering or ornamental designs. Instead of being imprinted on the protractor 20 or other instrument, the plurality of indicia 26 could be embossed on the appropriate surface. Alternatively, the front side 42 of the protractor 20 (or other instrument) could include “raised” surface that correspond to the plurality of indicia 26. Other methods of placing the plurality of indicia 26 on the protractor 20 or other instrument are known in the art and could also be used in conjunction with the present invention.

As shown in FIG. 2, the base 22 of the protractor 20 includes a cavity 28 within which at least one battery 30 may be placed. In one embodiment of the invention, two batteries 30, each having a voltage of about 3 volts, are used, although a single battery or multiple batteries of other sizes and voltages may also be used. The at least one battery 30 is coupled to a light source 34. The light source 34 is coupled to a sleeve 36 that partially surrounds the light source 34. The light source 34 is positioned such that, when actuated, the light source 34 will emit light along or through a pathway 40 within the arc portion 24. The light source 34 may comprise a light emitting diode (LED), although other types of light may also be possible. The at least one battery 30 is affixed to the inside of the cavity 28 at the base 22 by an adhesive tape 38 or similar bonding mechanism, which would be easily understood by those skilled in the art. The at least one battery 30, the light source 34 and the sleeve 36 are covered by a battery cap 32. In a preferred embodiment of the invention, the battery cap 32 substantially aligns with the base 22, permitting the protractor 20 to rest flat upon a surface such as a worktable (not shown).

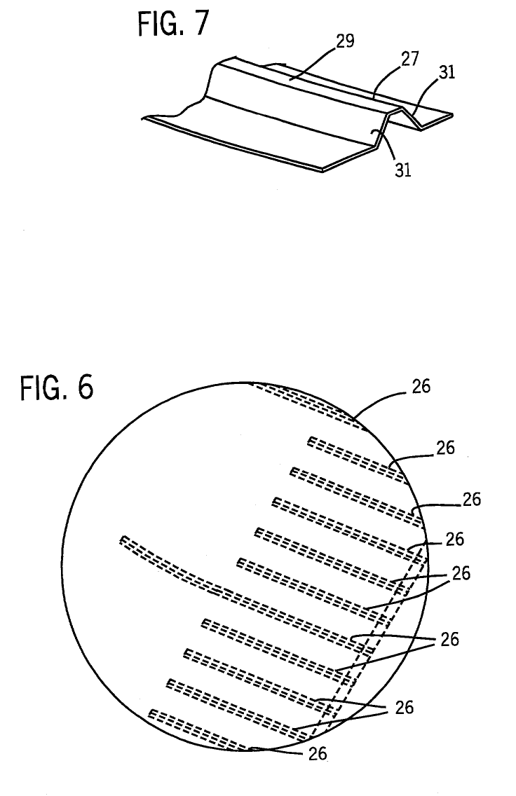

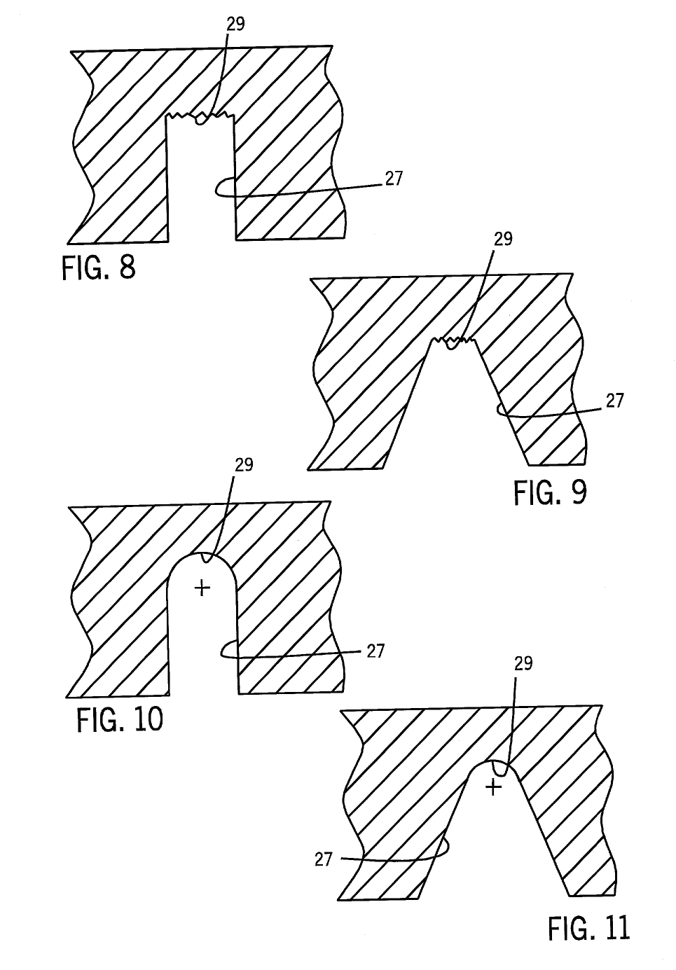

The plurality of the indicia 26 may comprise a plurality of individual grooves 27 strategically positioned within the protractor 20 along the pathway 40, as shown in FIGS. 6 and 7. The individual grooves 27 can be formed in a variety of shapes. For example, the individual grooves 27 can include an uneven or textured upper surface 29, as shown in FIGS. 8 and 9. The uneven or textured upper surface 29 may comprise small ridges, grooves, or similar structures. In another embodiment of the invention, the upper surface 29 of each individual groove 27 can be smooth and rounded, as shown in FIGS. 10 and 11. Additionally, the side walls 31 of each of the grooves 27 can be substantially perpendicular to a flat surface upon which the protractor 20 rests, as shown in FIGS. 8 and 10. Alternatively, the side walls 31 could be positioned at an angle to the surface, as shown in FIGS. 9 and 11. Other variations could be incorporated into ones of the individual grooves 27. As light from the light source 34 travels along or through the pathway 40, the individual grooves 27 illuminates by the light. The result of this illumination is that the entire plurality of the indicia 26 are illuminated, providing the user with an easier manner to view the plurality of the indicia 26.

The operation of the protractor 20 is generally as follows. When a user desires to use the protractor 20, the user places the back side 44 of the protractor 20 on a flat surface. The user presses firmly against the front side 42 of the protractor 20. The pressure exerted on the battery cap 32 against the at least one battery 30 results in an activation of the light source 34. The light source 34 transmits light along the pathway 40, which subsequently illuminates the indicia 26 along the arc portion 24 of the protractor 20. In an alternate embodiment of the invention, light emitted from the light source 34 may also illuminate indicia 26 along the base 22 of the protractor 20. The illumination of the indicia 26 on the protractor 20 aids the user in identifying and differentiating the indicia 26 along the arc portion 24 of the protractor 20.

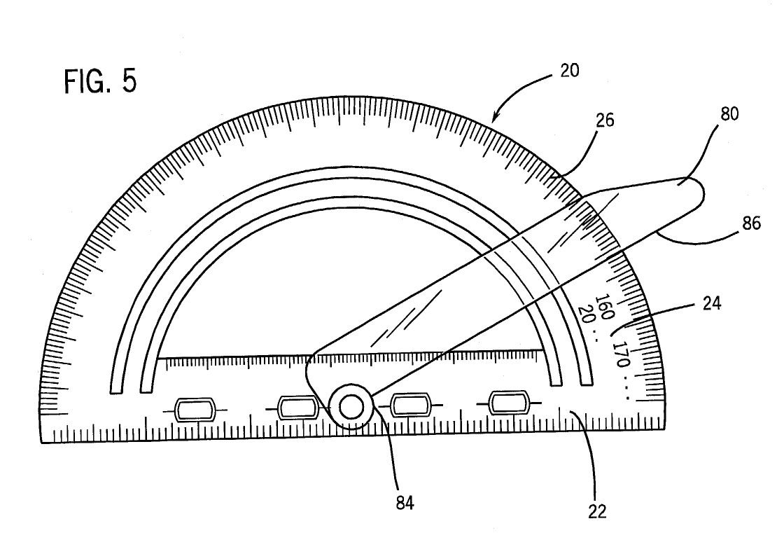

In one embodiment of the invention and as shown in FIG. 5, a lighting mechanism of the type described herein could be incorporated into the protractor 20 with a lever arm 80 which is coupled to the base 22, wherein the lever arm 80 is rotatable about an axis that is substantially orthogonal to the base 22. This axis runs substantially through the center point 82 of a zero degree line 84 on the base 22. The lever arm 34 includes a straight edge 86 that, combined with the zero degree line 84 of the base 22, describes an angle therebetween. The straight edge 86 of the lever arm 80 may intersect the indicia 26 on arc portion 24 of the protractor 20, helping the user to precisely define an angle. Protractors of this type are described in detail in U.S. Pat. No. 5,113,590, issued to Shapiro, and U.S. application Ser. No. 09/723,597 (assigned to the assignee of the present application), and both of which are incorporated by reference.

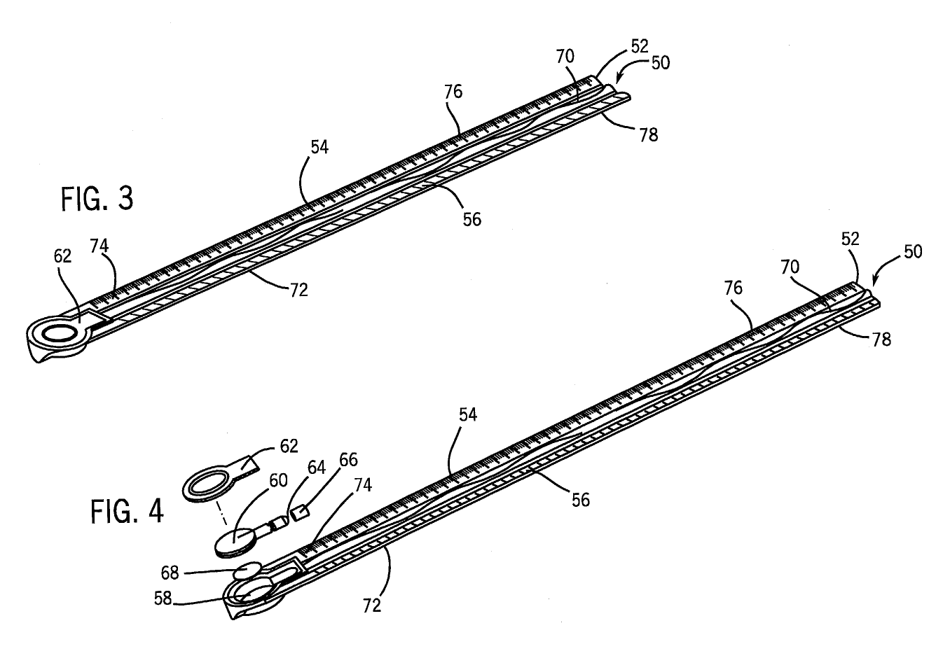

An additional embodiment of the invention is shown in FIGS. 3 and 4. A measurement instrument in the form of a ruler is shown generally at 50 in FIGS. 3 and 4. The ruler 50 includes a frame 52 with a front side 72 and a back side 74. The frame 52 may include a plurality of metric unit indicia 54 and/or English unit indicia 56 imprinted thereon or formed therein. In one embodiment of the invention, the metric unit indicia 54 mark the number of centimeters and/or millimeters along a first edge 76 of the frame 52, while the English unit indicia 56 mark the number of inches and fractions of inches along a second edge 78 of the frame 52. The English unit indicia 56 and the metric unit indicia 54 can comprise a plurality of grooves 27, as shown in FIGS. 6-11 and described above.

As shown in FIG. 4, the back side 74 of the frame 52 of the ruler 50 includes a cavity 58 within which at least one battery 60 may be placed. In one embodiment of the invention, a pair of batteries 60, each having a voltage of about 3 volts, are used, although a single battery or multiple batteries of other sizes and voltages may also be used. The at least one battery 60 is coupled to a light source 64. The light source 64 is coupled to a sleeve 66 that partially surrounds the light source 64. The light source 64 is positioned such that, when actuated, the light source 64 will emit light through a pathway 70 within the frame 52. The light source 64 may comprise an LED light, although other types of light sources may also be possible. The at least one battery 60 is affixed to the inside of the cavity 58 at the frame 52 by an adhesive tape 68 or similar bonding mechanism, which would be easily understood by those skilled in the art. The at least one battery 60, the light source 64 and the sleeve 66 are covered by a battery cap 62. In a preferred embodiment of the invention, the battery cap 62 substantially aligns with the frame 52, permitting the ruler 50 to rest flat upon a surface such as a worktable (not shown).

The operation of the ruler 50 is generally as follows. When a user desires to use the ruler 50, the user places the back side 74 of the ruler 50 on a flat surface and presses firmly against the front side 72 of the ruler 50. The pressure exerted on the battery cap 62 against the at least one battery 60 results in activation of the light source 64. The light source 64 transmits light along the pathway 70, which subsequently illuminates the metric unit indicia 54 and the English unit indicia 56 along the frame 52. The illumination of the metric unit indicia 54 and the English unit indicia 56 on the ruler 50 aids the user in identifying and describing proper and accurate measurements.

It should be understood that the above description of the invention and specific examples and embodiments, while indicating the preferred embodiments of the present invention, are given by demonstration and not limitation. For example, a variety of measurement instruments besides rulers and protractors could be developed for use with the present invention. Additionally, it is possible that the light source 64 could be actuated by methods other than simply pressing down upon the instrument. For example, the light source could be actuated with an on/off switch, or the light source 64 could be set to constantly provide a certain degree of light along the pathway. Many changes and modifications within the scope of the present invention may therefore be made without departing from the spirit thereof and the present invention includes all such changes and modifications.

What is claimed is:

1. A measurement instrument, comprising:
a frame including:
a first side,
a second side substantially opposite the first side and including a cavity therein,
a plurality of indicia, and
a pathway substantially between the first side and the second side;
a power source positioned within the cavity; and
a light source operatively connected to the power source and positioned to transmit light along the pathway.

2. The measurement instrument of claim 1, wherein when an external force is applied to the power source, the light source is actuated to transmit light along the pathway.

3. The measurement instrument of claim 1, wherein the power source comprises a battery.

4. The measurement instrument of claim 2, wherein the light source comprises a light emitting diode.

5. The measurement instrument of claim 1, wherein the light emitted from the light source illuminates the plurality of indicia.

6. The measurement instrument of claim 1, wherein the plurality of indicia are imprinted on the first side of the measurement instrument.

7. The measurement instrument of claim 1, wherein the plurality of indicia are embossed on the first side of the measurement instrument.

8. The measurement instrument of claim 1, wherein the plurality of indicia are positioned upon raised surfaces of the first side of the measurement instrument.

9. The measurement instrument of claim 1, wherein the plurality of indicia include designations for measuring linear distances.

10. The measurement instrument of claim 1, wherein the plurality of indicia include designations for measuring angular distances.

11. The measurement instrument of claim 1, wherein the measurement comprises a ruler.

12. The measurement instrument of claim 1, wherein the measurement instrument comprises a protractor.

13. The measurement instrument of claim 12, further comprising a lever arm rotatably coupled to the frame.

14. The measurement instrument of claim 1, wherein the plurality of indicia comprise a plurality of grooves formed into one of the first side and the second side.

15. The measurement instrument of claim 14, wherein each of the plurality of grooves include a textured surface substantially parallel to the first side and the second side.

16. The measurement instrument of claim 14, wherein each of the plurality of grooves include a smooth surface substantially parallel to the first side and the second side.

17. The measurement instrument of claim 14, wherein each of the plurality of grooves include a pair of side walls substantially perpendicular to the first side and the second side.

18. A measurement instrument, comprising:
a frame including:
a first side,
a second side substantially opposite the first side
a plurality of indicia, and
a pathway substantially between the first side and the second side; and
means for illuminating the plurality of indicia.

19. The measurement instrument of claim 18, wherein the measurement comprises a ruler.

20. The measurement instrument of claim 18, wherein the measurement instrument comprises a protractor.
